(19) United States
(12) Patent Application Publication
(10) Pub. No.: US 2014/0207589 A1
(43) Pub. Date: Jul. 24, 2014

(54) ORDER RECEIVING APPARATUS AND ORDER RECEIVING METHOD

(71) Applicant: TOSHIBA TEC KABUSHIKI KAISHA, TOKYO (JP)

(72) Inventors: Shigeki Nimiya, Kanagawa-ken (JP); Katsuhito Mochizuki, Shizuoka-ken (JP)

(73) Assignee: TOSHIBA TEC KABUSHIKI KAISHA, TOKYO (JP)

(21) Appl. No.: 14/159,633

(22) Filed: Jan. 21, 2014

(30) Foreign Application Priority Data
Jan. 22, 2013 (JP) 2013-009115

(51) Int. Cl. G06Q 50/12; G06Q 30/06

(52) U.S. Cl. CPC G06Q 50/12; G06Q 30/0633
USPC 705/15

(57) ABSTRACT

An order receiving apparatus comprises a first storage section configured to store an amount obtained by adding up the prices of the menu items the order on which is received and a second storage section configured to store an amount obtained by adding up the prices of the menu items the order on which is determined. The apparatus adds the price of each menu item to the first storage section every time the order on the menu item is received, adds the amount in the first storage section to the second storage section in response to the determination of the order, and then clears the first storage section. The apparatus outputs the amounts stored in the first and second storage sections.

### CROSS-REFERENCE TO RELATED APPLICATION

This application is based upon and claims the benefit of priority from Japanese Patent Application No. 2013-009115, filed Jan. 22, 2013, the entire contents of which are incorporated herein by reference.

### FIELD

Embodiments described herein relate to an order receiving apparatus for use in an eating house and an order receiving method for enabling a computer to function as the order receiving apparatus.

### BACKGROUND

In recent years, an order management system which uses an order terminal as an order receiving apparatus is established in an eating house such as a family restaurant or a pub. The order terminal receives the order of customer desired menu items. The order data of the menu items input in the order terminal is sent to an order management server through wireless communication. The server manages the order data received from the order terminal.

Self-type order management systems have been used in practice in which an order terminal is arranged on a dining table. The customer at a dining table operates the order terminal on the dining table to order desired menu items. A list of various menu items is displayed on the display of the order terminal. The customer selects desired menu items from the list and instructs the order terminal to send order data after inputting the content of an order.

The customer serving as a user of the order terminal can know the price of each desired menu item from the list displayed on the order terminal.

However, it is difficult for the customer to know the total amount of the plurality of menu items the customer desires to order before making an order.

### BRIEF DESCRIPTION OF THE DRAWINGS

FIG. 1 is a diagram illustrating the whole configuration of a self-type order management system;

FIG. 2 is a block diagram illustrating a constitution of main portions of an order terminal;

FIG. 3 is a schematic diagram illustrating the main memory area formed in a RAM of an order terminal;

FIG. 4 is a flowchart illustrating a processing procedure of a new order job executed by a CPU in accordance with an order receiving program;

FIG. 5 is a flowchart illustrating a processing procedure of an order addition job executed by a CPU in accordance with an order receiving program;

FIG. 6 is a schematic diagram illustrating an example of an order receiving screen in a new order job;

FIG. 7 is a schematic diagram illustrating an example of an order receiving screen in an order addition job;

FIG. 8 is a schematic diagram illustrating an example of a screen transition when a tab in the exemplary screen shown in FIG. 7 is slid;

FIG. 9 is a schematic diagram illustrating an example of another screen transition when a tab in the exemplary screen shown in FIG. 7 is slid; and

FIG. 10 is a schematic diagram illustrating an example of a screen transition when the unordered item amount shown in the exemplary screen shown in FIG. 9 is selected.

### DETAILED DESCRIPTION

In accordance with an embodiment, an order receiving apparatus comprises an order receiving unit, an order determination unit, an order output unit, a first storage section, a second storage section, a price processing unit and an amount output unit. The order receiving unit receives the order on menu items. The order determination unit determines the order on the menu items received by the order receiving unit. The order output unit outputs, to a server, the data of the menu items the order on which is determined by the order determination unit. The first storage section stores an amount obtained by adding up the prices of the menu items the order on which is received by the order receiving unit. The second storage section stores an amount obtained by adding up the prices of the menu items the order on which is determined by the order determination unit. The price processing unit accumulates the price of each menu item the order on which is received by the order receiving unit in the first storage section, accumulates the total amount stored in the first storage section in the second storage section in response to the determination of the order by the order determination unit, and clears the first storage section. The amount output unit outputs the total amounts stored in the first and second storage sections.

Embodiments of the order receiving apparatus are described in detail below with reference to accompanying drawings.

Additionally, in the embodiments, the functions involved herein are applied to the order receiving apparatus (hereinafter referred to as an order terminal 1) of a self-type order management system.

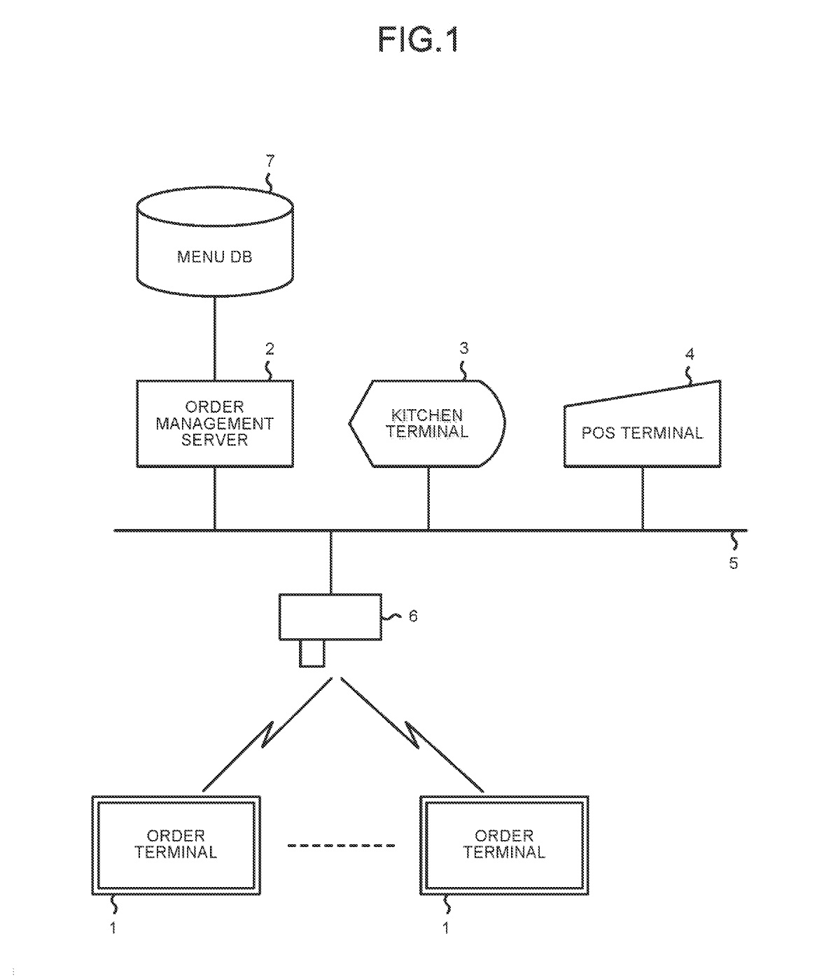

FIG. 1 is a diagram illustrating the whole configuration of a self-type order management system. The system comprises a plurality of order terminals 1, an order management server 2, a kitchen terminal 3 and a POS terminal 4. The order management server 2, the kitchen terminal 3 and the POS terminal 4 are connected with each other via an LAN (Local Area Network) 5 in a communicable manner. A wireless base station 6 capable of conducting wireless communication with each order terminal 1 is connected with the LAN 5.

Functioning as a device for informing a cook in the kitchen of the information of the ordered menu items received from a customer, the kitchen terminal 3 has a notification unit such as a display or printer. The POS terminal 4 functions as a device for a checkout processing of a customer who finishes his/her meal. Additionally, only one kitchen terminal 3 and only one POS terminal 4 are shown in FIG. 1, however, the numbers of the kitchen terminals 3 and the POS terminals 4 are not limited to be 1.

The order management server 2 accesses a menu database 7 and controls the reading/writing of data. A menu record created for each food and drink menu offered in the restaurant are stored in the menu database 7. The menu record of one food and drink menu contains a menu code uniquely assigned for each menu item, a menu name, a menu image, a price and the like.

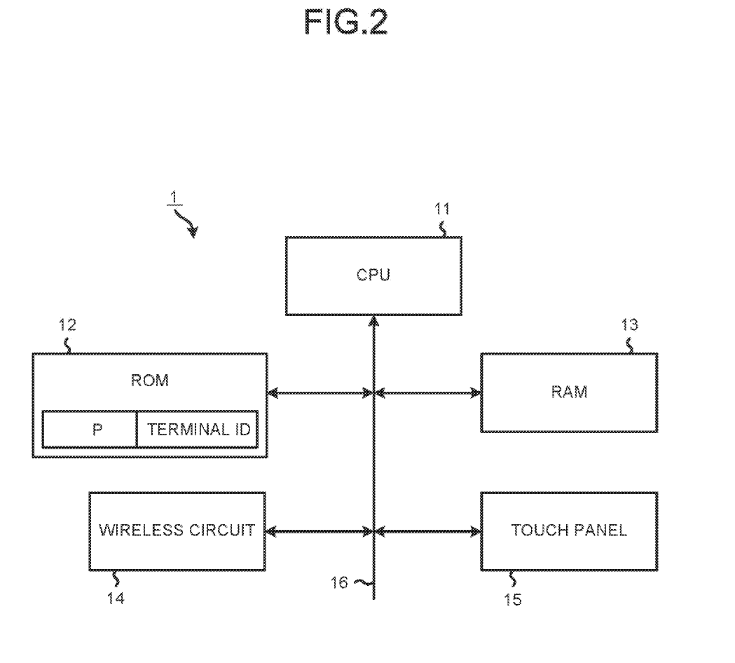

FIG. 2 is a block diagram illustrating a main constitution of the order terminal 1. As shown in FIG. 2, the order terminal 1 comprises a CPU (Central Processing Unit) 11, a ROM (Read Only Memory) 12, a RAM (Random Access Memory) 13, a wireless circuit 14, a touch panel 15 and a bus line 16. The bus line 16 including an address bus line and a data bus line connects the CPU 11 with the ROM 12 and the RAM 13. Further, the bus line 16 connects the wireless circuit 14 and the touch panel 15 via an input/output circuit (not shown).

The CPU 11 controls each section according to programs to realize various jobs of the order terminal 1. The ROM 12 stores fixed data such as programs and set data. The RAM 13 has various memory areas for storing variable data. The wireless circuit 14 establishes a wireless line with the wireless base station 6, and controls data transmission/reception in a wireless manner. The touch panel 15 functions as an interface for a user to use the order terminal 1.

In each order terminal 1 with such a constitution, an order receiving program P and a fixed terminal ID are stored in the ROM 12.

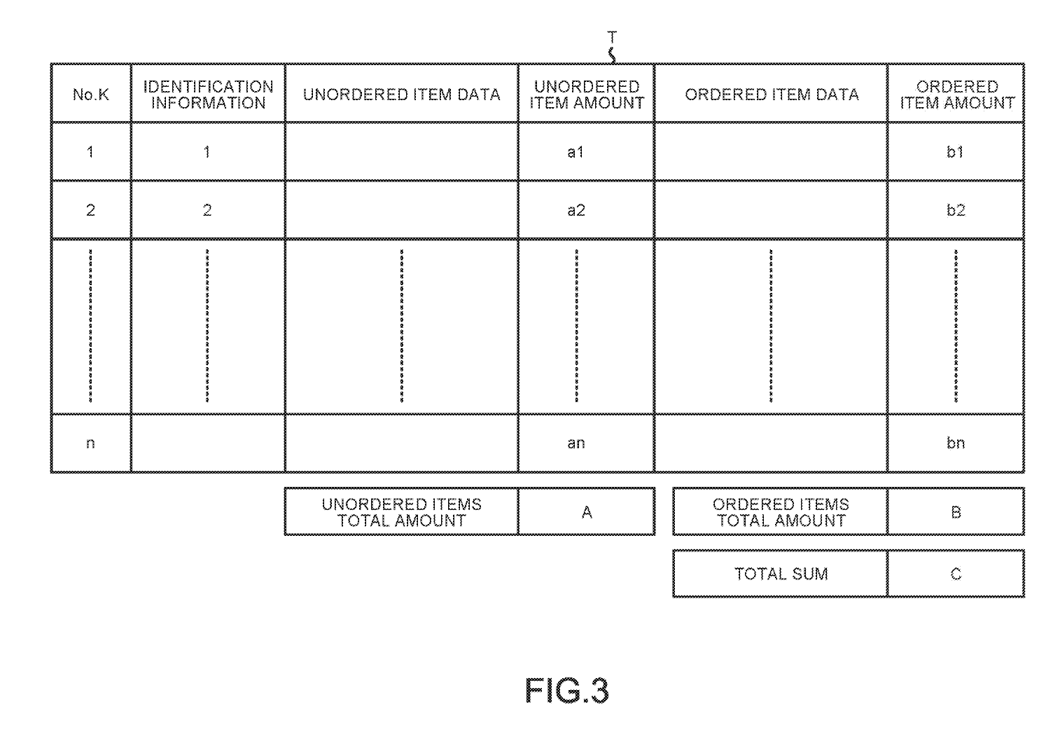

Further, as shown in FIG. 3, the RAM 13 has an order table T, a memory area for an unordered items total amount A, a memory area for an ordered items total amount B and a memory area for a total sum C.

The order table T has an area for storing identification information, unordered item data, unordered item amounts a1-an, ordered item data and ordered item amounts b1-bn in association with a series of user numbers K (1−n). The total amount of the unordered item amounts a1-an stored in the order table T is stored in the memory area for an unordered items total amount A. The total amount of the ordered item amounts b1-bn stored in the order table T is stored in the memory area for an ordered items total amount B. The total amount of the unordered items total amount A and the ordered items total amount B is stored in the memory area for a total sum C.

Each order terminal 1 is separately arranged on a dining table in the eating house. The user number K of the order table T is assigned to each user (customer) sitting around the dining table equipped with the order terminal 1. The identification information is data for identifying a user assigned with a corresponding user number K. The identification information may be text data such as characters or marks and the like, or image data such as an avatar.

Unordered item data, which is selected by the user assigned with a corresponding user number K, refers to menu codes and menu names of menu items the order on which is not determined. Unordered item amounts 1a-an are total amounts of the prices of the menu items stored in the order table T as the aforementioned unordered item data. Ordered item data, which is selected by the user assigned with a corresponding user number K, refers to menu codes and menu names of menu items the order on which is determined. The ordered item amounts b1-bn are total amounts of the prices of the menu items stored in the order table T as the aforementioned ordered item data.

The memory area for an unordered items total amount A, in which the total amount of the aforementioned unordered item amounts a1-an is stored, constitutes the first storage section. The memory area for an ordered items total amount B, in which the total amount of the aforementioned ordered item amounts b1-bn is stored, constitutes the second storage section.

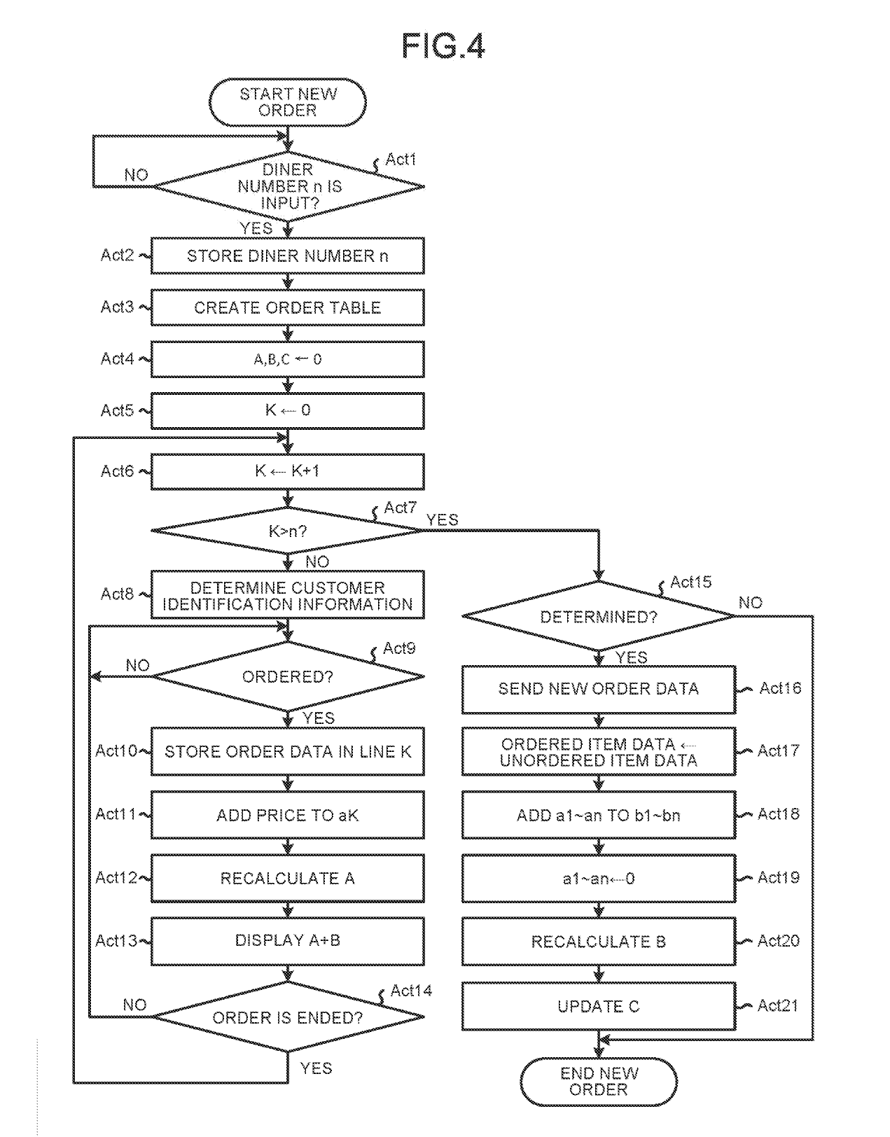

In the order terminal 1 the CPU 11 of which is in an idling state, the order receiving program P is started when the touch panel 15 is touched. The CPU 11 starts a new order job in a procedure illustrated in the flowchart of FIG. 4 in response to the starting of the order receiving program P. First, the CPU 11 displays a diner number input screen the touch panel 15 to urge the input of the number n of the diners sitting at a dining table (ACT 1).

The customer confirming the diner number input screen operates the touch panel 15 to input a diner number n. If a diner number n is input (YES in ACT 1), the CPU 11 writes the diner number n in a diner number memory (ACT 2). The diner number memory is formed in the RAM 13.

The CPU 11 creates, in the RAM 13, the order tables T corresponding to the diner number n (ACT 3). Further, the CPU 11 clears the memory areas in the RAM 13 for an unordered items total amount A, an ordered items total amount B and a total sum C (ACT 4).

The CPU 11 resets a counter K to be 0 (ACT 5). Next, the CPU 11 accumulatively adds 1 to the counter K (ACT 6). Then, the CPU 11 confirms whether or not the counter K is higher than the diner number n (ACT 7).

If the counter K is not higher than the diner number n (NO in ACT 7), the CPU 11 executes a customer identification information determination processing. For example, the CPU 11 displays a soft keyboard for the input of characters on the touch panel 15 and urges the text input of identification information. Alternatively, the CPU 11 displays a plurality of avatars prepared in advance on the touch panel 15 and urges a selection input. The CPU 11 sets the input text data or the image data of the selected avatar in an identification information area associated with the user number accordant with the counter K in the order table T (ACT 8: user specification unit).

The CPU 11 displays an order receiving screen on the touch panel 15 and receives an order on menu items (ACT 9: order receiving unit). A list, in which the menu code, the item name or image and the price of each menu item are set in association with each other, is displayed on the order receiving screen based on the data of the menu database 7. The customer touches desired menu items.

If a menu item is ordered (YES in ACT 9), the CPU 11 adds the menu code of the menu item to an unordered item data area which is set in association with the user number accordant with the counter K in the order table T (ACT 10). Further, the CPU 11 adds the price of the menu item to the unordered item amount aK of the same user number K (ACT 11: price processing unit).

The CPU 11 adds up the unordered item amounts a1-an in the order table T to calculate an unordered items total amount A (ACT 12). Further, the CPU 11 adds the unordered items total amount A to the ordered items total amount B to calculate a total sum C. Then, the CPU 11 displays the total sum C on a part of the order receiving screen (ACT 13: amount output unit).

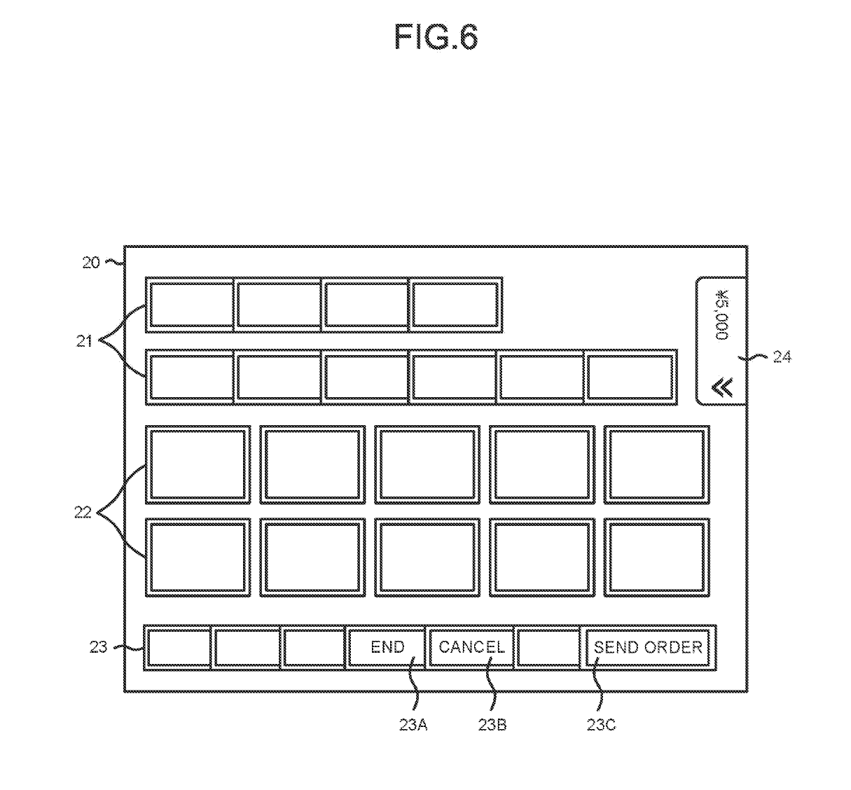

FIG. 6 shows an example of the order receiving screen 20 on which the total sum C is displayed. A plurality of category buttons 21, a plurality of menu item buttons 22 and a plurality of function buttons 23 are arranged on the order receiving screen 20. Category item for classifying various menu items is assigned to each category button 21. The menu item belonging to the category item assigned to the button selected from each category button 21 is assigned to each menu item button 22.

The function buttons 23 include a button ‘end’ 23A, a button ‘cancel’ 23B and a button ‘send order’ 23C. The button ‘end’ 23A is input when the customer identified based on identification information ends an order on menu items. The button ‘cancel’ 23B is input when the customer cancels an order. The button ‘send order’ 23C is input when the customer determines an order.

In the present embodiment, as shown in FIG. 6, a tab 24, in which the total sum C is displayed, is displayed on the right end of the order receiving screen 20.

The CPU 11 confirms whether or not the button ‘end’ 23A is input (ACT 14). If the button ‘end’ 23A is not input (NO in ACT 14), the CPU 11 receives an order on a next menu item (ACT 9). Moreover, if a menu item is ordered (YES in ACT 9), the CPU 11 executes the processing of ACT 10-ACT 14 again.

If the button ‘end’ 23A is input (YES in ACT 14), the CPU 11 further adds ‘1’ to the counter K again (ACT 6). Then, the CPU 11 confirms whether or not the counter K is higher than the diner number n again (ACT 7). The CPU 11 executes the processing of ACT 8-ACT 14 if the counter K is not higher than the diner number n (NO in ACT 7).

If the counter K is higher than the diner number n (YES in ACT 7), the CPU 11 displays guidance for an order determination request on the touch panel 15 and urges an input indicative of whether or not an order is determined (ACT 15).

The customer confirming the guidance for an order determination request determines whether or not to determine the order. If the order is determined, the customer touches the button ‘send order’ 23C. If desiring to cancel the order, the customer touches the button ‘cancel’ 23B.

The CPU 11 displaying the guidance waits until the button ‘send order’ 23C or the button ‘cancel’ 23B is input. When the button ‘send order’ 23C is input (YES in ACT 15), the CPU 11 regards the unordered item data stored in the order table T as new order data. Then, the CPU 11 adds the terminal ID stored in the ROM 12 to the new order data and wirelessly sends the resulting data to the order management server 2 (ACT 16).

The order management server 2 stores the new order data received from the order terminal 1 for each terminal ID assigned to the data. Further, the order management server 2 outputs cooking instruction data of the menu items specified using the new order data to the kitchen terminal 3.

The CPU 11 of the order terminal 1 which has sent the new order data transmits the unordered item data stored in the order table T for each user number to corresponding ordered item data area in the same table T and clears the aforementioned unordered item data (ACT 17). Further, the CPU 11 adds the unordered item amounts a1-an stored in the order table T for each user number to corresponding ordered item amounts b1-bn in the same table T (ACT 18). Then, the CPU 11 clears the aforementioned unordered item amounts a1-an (ACT 19: price processing unit).

The CPU 11 adds up the ordered item amounts b1-bn in the order table T to calculate an ordered items total amount B (ACT 20). Then, the CPU 11 transmits the ordered items total amount B to the total sum C to update the total sum C (ACT 21). Then, the CPU 11 ends the new order job.

Additionally, in ACT 15, if the button ‘cancel’ 23B is input (NO in ACT 15), then the CPU 11 ends the new order job without executing the processing of ACT 16-ACT 21.

An order addition job can be carried out in the order terminal 1 when the new order job is ended. Like the new order job, the order addition job is also based on the order receiving program P.

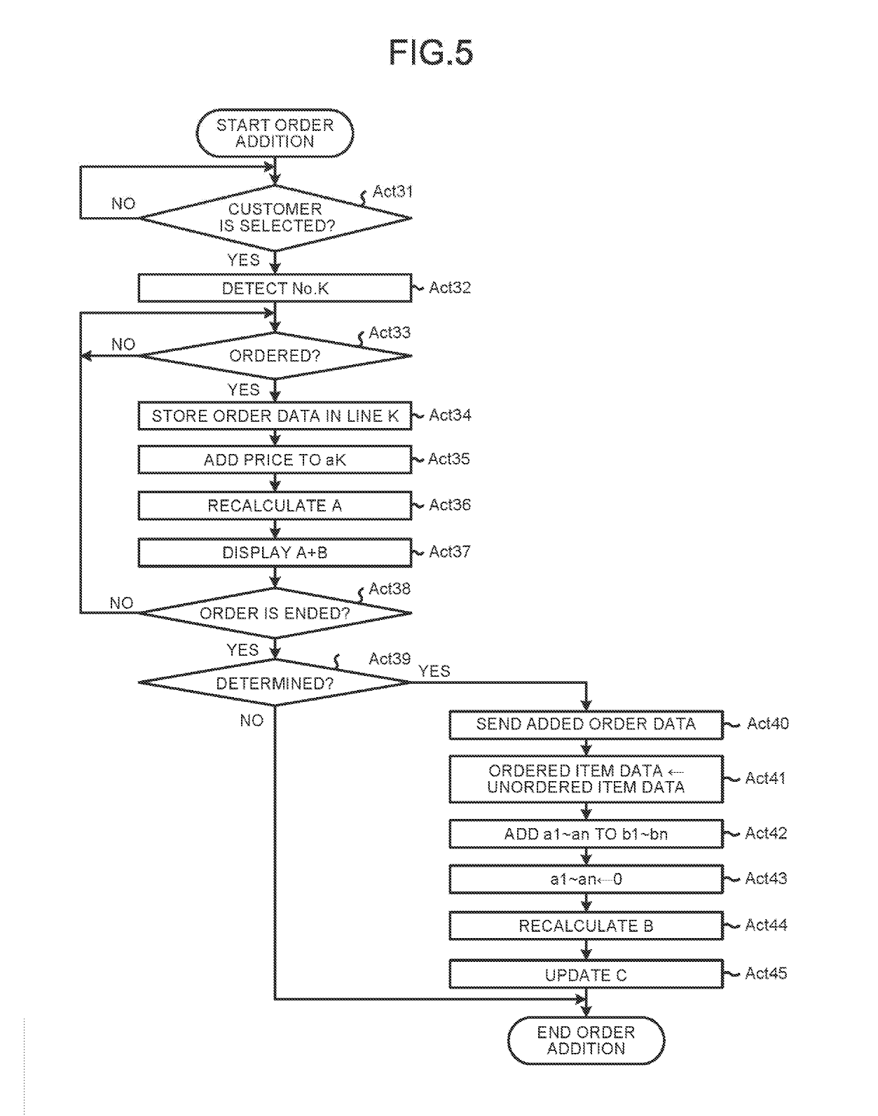

For example, when a button ‘add order’ on the touch panel 15 is touched, the CPU 11 starts an order addition job in a procedure illustrated in the flowchart of FIG. 5. First, the CPU 11 displays an identification information selection screen on the touch panel 15 to urge the selection and input of identification information for specifying a customer adding an order (ACT 31).

The identification information of each user stored in the order table T is selectively displayed on the identification information selection screen. Thus, the customer confirming the identification information selection screen operates the touch panel 15 to select identification information thereof. If identification information is selected (YES in ACT 31), the CPU 11 detects, from the order table T, the user number K stored corresponding to the selected identification information (ACT 32).

Next, the CPU 11 displays an order receiving screen on the touch panel 15 and receives an order on menu items (ACT 33: order receiving unit). If a menu item is ordered (YES in ACT 33), the CPU 11 executes the same processing as that in ACT 10-ACT 14 in the new order job. That is, the CPU 11 adds the menu code of the menu item the order on which is received to the unordered item data area which is set in association with the user number K in the order table T (ACT 34). Further, the CPU 11 adds the price of the menu item to the unordered item amount aK of the same user number K (ACT 35: price processing unit).

The CPU 11 adds up the unordered item amounts a1-an in the order table T to calculate an unordered items total amount A (ACT 36). Further, the CPU 11 adds the unordered items total amount A to the ordered items total amount B to calculate a total sum C. Then, the CPU 11 displays the total sum C on a part of the order receiving screen (ACT 37: amount output unit).

The CPU 11 confirms whether or not the button ‘end’ 23A is input (ACT 38). If the button ‘end’ 23A is not input (NO in ACT 38), the CPU 11 receives an order on a next menu item (ACT 33). Sequentially, if a menu item is ordered (YES in ACT 33), the CPU 11 executes the processing of ACT 34-ACT 38 again.

If the button ‘end’ 23A is input (YES in ACT 38), the CPU 11 displays guidance for an order determination request on the touch panel 15 and urges an input indicative of whether or not an order is determined (ACT 39). If the button ‘send order’ 23C is input (YES in ACT 39), the CPU 11 executes the same processing as that in ACT 16-ACT 21 in the new order job.

That is, the CPU 11 regards the unordered item data stored in the order table T as added order data. Then, the CPU 11 adds the terminal ID to the added order data and wirelessly sends the resulting data to the order management server 2 (ACT 40). Afterwards, the CPU 11 transmits the unordered item data stored in the order table T for each user number to corresponding ordered item data areas in the same table T and clears the aforementioned unordered item data (ACT 41). Further, the CPU 11 adds the unordered item amounts a1-an stored in the order table T for each user number to corresponding ordered item amounts b1-bn in the same table T (ACT 42). Then, the CPU 11 clears the aforementioned unordered item amounts a1-an (ACT 43: price processing unit). Next, the CPU 11 adds up the ordered item amounts b1-bn in the order table T to calculate an ordered items total amount B (ACT 44). Sequentially, the CPU 11 transmits the ordered items total amount B to the total sum C to update the total sum C (ACT 45). Then, the CPU 11 ends the order addition job.

In addition, the order management server 2 stores the added order data received from the order terminal 1 for each terminal IDs assigned to the data. Further, the order management server 2 outputs cooking instruction data of the menu items specified using the added order data to the kitchen terminal 3.

Further, in ACT 39, if the button ‘cancel’ 23B is input (NO in ACT 39), the CPU 11 ends the order addition job without executing the processing of ACT 40-ACT 45.

Next, the effect of the present embodiment is described below based on an example of an order terminal 1 arranged on a dining table around which a group of three customers sit. Further, the three customers are respectively identified using identification information AA, BB and CC.

In the new order job, the customer identified by the identification information AA orders 5,000 Yen of menu items, the customer identified by the identification information BB orders 3,000 Yen of menu items, the customer identified by the identification information CC orders 2,000 Yen of menu items; and the button ‘send order’ 23C is input. In this case, in the order table T, an ordered item amount ‘5,000 Yen’ is stored in association with the identification information AA, an ordered item amount ‘3,000 Yen’ is stored in association with the identification information BB, and an ordered item amount ‘2,000 Yen’ is stored in association with the identification information CC. Further, the ordered items total amount B and the total sum C are both 10,000 Yen. Besides, as unordered item amounts set in association with the identification information AA, BB and CC are cleared, therefore, the unordered items total amount A is 0 Yen.

Next, in the order addition job, the customer identified by the identification information AA and the customer identified by the identification information BB both order 1,000 Yen of menu items, and the customer identified by the identification information CC orders 345 Yen of menu items. When the button ‘send order’ 23C is not input, in the order table T, an unordered item amount ‘1,000 Yen’ is stored in association with the identification information AA, an unordered item amount ‘1,000 Yen’ is stored in association with the identification information BB, and an unordered item amount ‘345 Yen’ is stored in association with the identification information CC. Further, the unordered items total amount A is 2,345 Yen and the total sum C is 12,345 Yen.

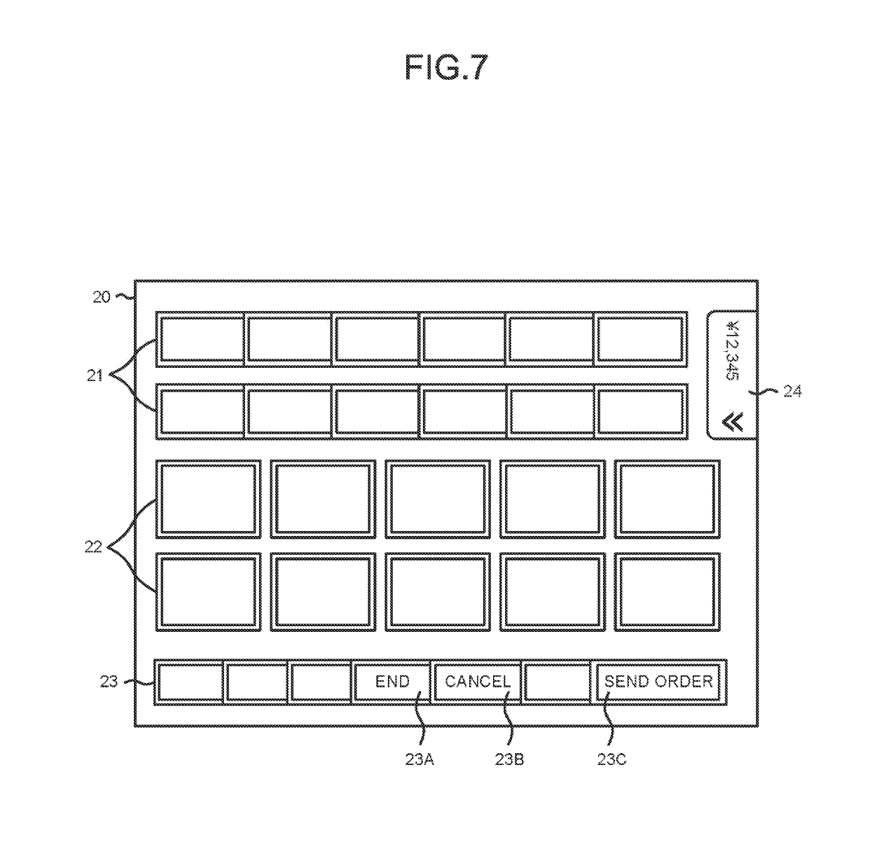

At this time, as shown in FIG. 7, the total sum C ‘12,345 Yen’ is displayed in the tab 24 of the order receiving screen 20. By means of the display, the customer, before determining the order for this time, can be aware of the total price of the menu items the order on which has been determined and the menu items to be ordered for this time.

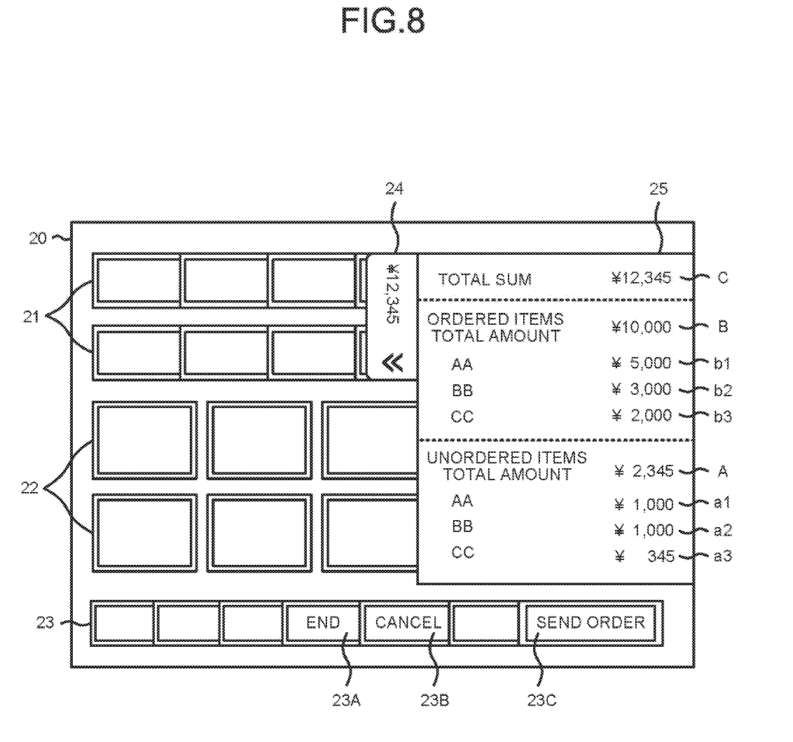

Herein, in the exemplary screen shown in FIG. 7, the tab 24 is slid leftwards by the customer. Consequentially, a window 25 is pulled out and displayed following the tab 24, as shown in FIG. 8. In the window 25, the total sum C, the ordered items total amount B, ordered item amounts b1, b2 and b3 of different customers, the unordered items total amount A, and unordered item amounts a1, a2 and a3 of different customers are displayed in sequence. By means of the display, the customers can be aware of details of the total sum C including the menu items the order on which is not determined.

The customer, after confirming the details, determines whether or not to make an order. After determining to order, the customer touches the button ‘send order’ 23C. After determining to cancel the order, the customer touches the button ‘cancel’ 23B.

If the button ‘send order’ 23C is input, the order of the unordered item data is determined. As a result, the ordered items total amount B and the total sum C are both updated to be 12,345 Yen. Likewise, the ordered item amount set in association with the identification information AA is updated to be 6,000 Yen, the ordered item amount set in association with the identification information BB is updated to be 4,000 Yen, and the ordered item amount set in association with the identification information CC is updated to be 2,345 Yen.

In this way, according to the present embodiment, the user of the order terminal can be aware of the total price of the menu items to be ordered before determining the order. Moreover, it is convenient for a group of customers as each of the customers can be aware of his/her own total amount before determining the order.

Further, in the present embodiment, as shown in FIG. 6 and FIG. 7, the tab 24 for displaying the total sum C is displayed on the right end of the order receiving screen 20. Thus, the plurality of category buttons 21 and the plurality of menu item buttons 22 displayed on the order receiving screen 20 are not hidden by the tab 24. On the other hand, when the tab 24 is slid to confirm the details of the total sum, the window 25 is displayed on the screen without, however, hiding the image of the function buttons 23. Thus, the customer confirming the details can directly input the button ‘cancel’ 23B or the button ‘send order’ 23C with the window 25 displayed.

Further, as stated above, the window 25 is limited in size. Thus, it is difficult to display all details in one window 25 for a customer group consisting of many customers.

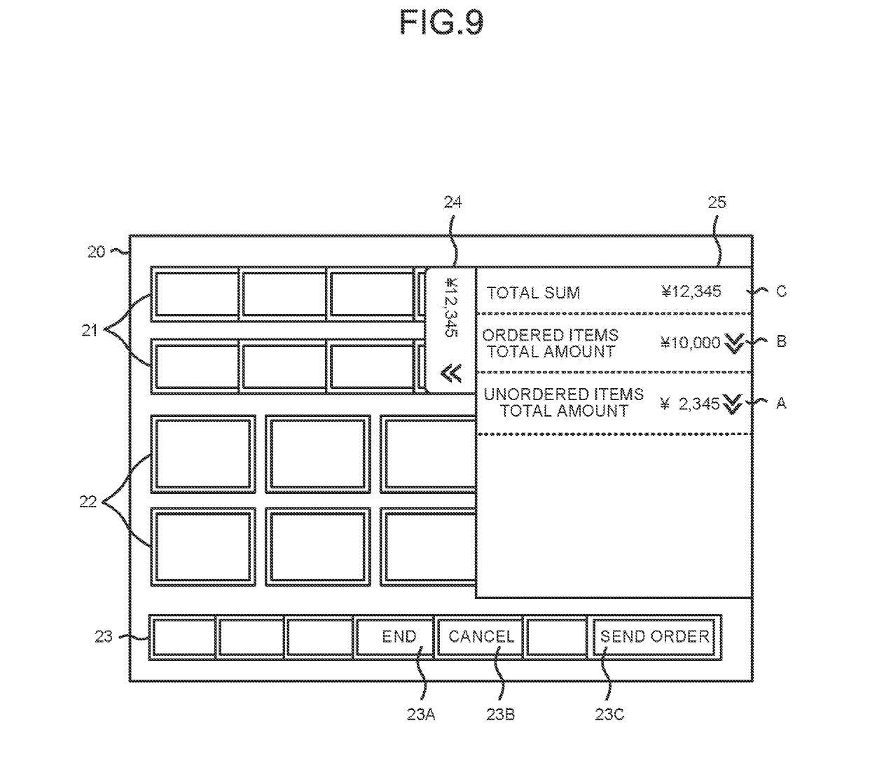

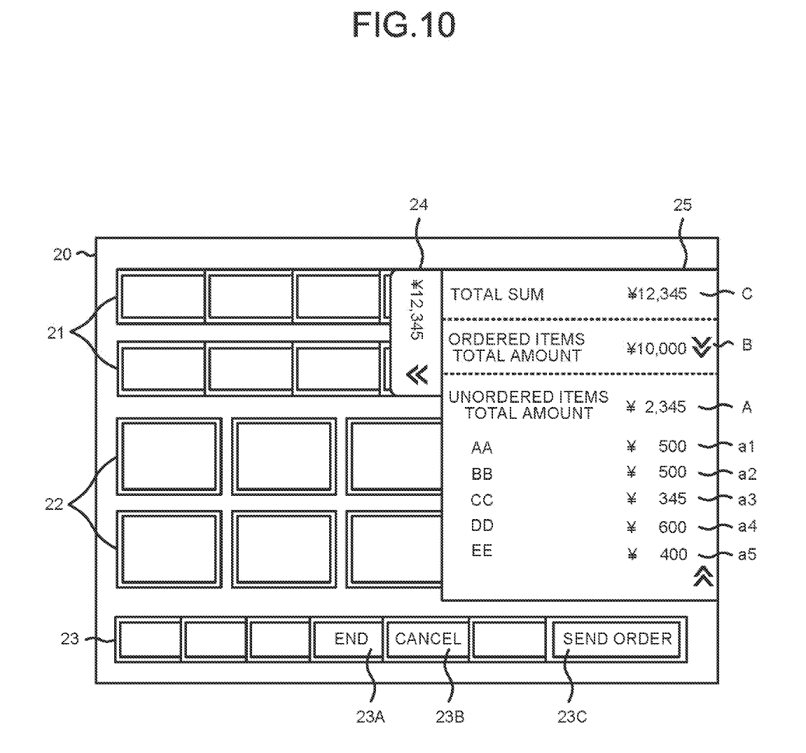

Thus, as another embodiment, the total sum C, the ordered items total amount B and the unordered items total amount A are displayed in the window 25 which is pulled out through the sliding of the tab 24, as shown in FIG. 9. Herein, for example, if the unordered items total amount A is touched, details of the unordered items total amount A are displayed in the window 25, as shown in FIG. 10. Similarly, if the ordered items total amount B is touched, then details of the ordered items total amount B are displayed in the window 25. With such a configuration, before an order is made, the total price and details of the menu items to be ordered can be easily confirmed without impairing the operability of the order receiving screen 20.

Further, the present invention is not limited to the embodiments above.

For example, in the embodiments described above, the tab 24 is displayed on the right end of the order receiving screen 20; however, the tab 24 may also be displayed on the left, upper or lower end of the order receiving screen 20. For example, when the tab 24 is displayed on the upper end of the order receiving screen 20, the window 25 is pulled out from the top of the screen down.

Further, in the embodiments described above, the man-machine interface of the order terminal 1 is set as the touch panel 15; however, it may also be a device consisting of a display device such as a liquid crystal display and an input device such as a keyboard or mouse and the like.

Further, the order terminal 1 of a self-type order management system is exemplified in the embodiments described above; however, an order terminal 1 of an order management system not in a self-type is also applicable.

Further, in the embodiment described above, the order receiving program is pre-recorded in the ROM 12 serving as a program storage section in the apparatus to realize the functions of the present invention. However, the present invention is not limited to this, the same program may be downloaded to the apparatus from a network. Alternatively, the same program recorded in a recording medium may be also installed in the apparatus. The form of the recording medium is not limited as long as the recording medium can store methods like a CD-ROM and a memory card and is readable by an apparatus. Further, the function realized by an installed or downloaded program can also be achieved through the cooperation with an OS (Operating System) installed in the apparatus. Moreover, the program described in the present embodiments may be assembled in a portable information terminal such as a mobile telephone having a communication function or the called PDA to realize the function.

While certain embodiments have been described, these embodiments have been presented by way of example only, and are not intended to limit the scope of the invention. Indeed, the novel embodiments described herein may be embodied in a variety of other forms; furthermore, various omissions, substitutions and changes in the form of the embodiments described herein may be made without departing from the spirit of the invention. The accompanying claims and their equivalents are intended to cover such forms or modifications as would fall within the scope and spirit of the invention.

What is claimed is:

1. An order receiving apparatus, comprising:
an order receiving unit configured to receive an order on menu items;
an order determination unit configured to determine the order on the menu items received by the order receiving unit;
an order output unit configured to output, to a server, the data of the menu items the order on which is determined by the order determination unit;
a first storage section configured to store an amount obtained by adding up the prices of the menu items the order on which is received by the order receiving unit;
a second storage section configured to store an amount obtained by adding up the prices of the menu items the order on which is determined by the order determination unit;
a price processing unit configured to add the price of each menu item to the first storage section every time the order on the menu item is received by the order receiving unit, add the amount stored in the first storage section to the second storage section in response to the determination of the order carried out by the order determination unit, and clear the first storage section; and
an amount output unit configured to output the amounts stored in the first and second storage sections.

2. The order receiving apparatus according to claim 1, wherein
the amount output unit outputs the total amount of the amount stored in the first storage section and the amount stored in the second storage section.

3. The order receiving apparatus according to claim 2, further comprising:
a display section configured to display a list screen of menu items the order on which can be received by the order receiving unit; wherein
the amount output unit displays the total amount of the amounts stored in the first and second storage sections on a part of the list screen in a tab form.

4. The order receiving apparatus according to claim 3, wherein
the amount output unit displays the total amount of the amounts stored in the first and second storage sections on a part of the list screen in a tab form, and
displays the amounts stored in the first and second storage sections on the list screen in response to the sliding operation of the tab.

5. The order receiving apparatus according to claim 1, further comprising:
a user specification unit configured to specify a user ordering menu items; wherein
the first storage section stores an amount obtained by adding up the prices of the menu items the order on which is received from a user for each user specified by the user specification unit, and
the second storage section stores an amount obtained by adding up the prices of the menu items the order on which is received and determined from a user for each user specified by the user specification unit.

6. The order receiving apparatus according to claim 5, wherein
the amount output unit outputs
the amount obtained by adding up the total amount of each user stored in the first storage,
the amount obtained by adding up the total amount of each user stored in the second storage section, and
the total sum of the amount obtained by adding up the total amount of each user stored in the first storage section and the amount obtained by adding up the total amount of each user stored in the second storage section.

7. The order receiving apparatus according to claim 6, further comprising:
a display section configured to display a list screen of menu items the order on which can be received by the order receiving unit; wherein
the amount output unit displays the total sum of the amount obtained by adding up the total amount of each user stored in the first storage section and the amount obtained by adding up the total amount of each user stored in the second storage section on a part of the list screen in a tab form.

8. The order receiving apparatus according to claim 7, wherein
the amount output unit displays the total sum of the amount obtained by adding up the total amount of each user stored in the first storage section and the amount obtained by adding up the total amount of each user stored in the second storage section on a part of the list screen in a tab form, and
displays the total amount of each user stored in the first storage section and the total amount of each user stored in the second storage section on the list screen in response to the sliding operation of the tab.

9. An order receiving method, including:
receiving an order on menu items;
determining the received order on the menu items;
outputting, to a server, the data of the menu items the order on which are determined;
adding the price of each menu item to the first storage section every time the order on the menu item is received, adding the amount stored in the first storage section to the second storage section in response to the determination of the order, and clearing the first storage section; and
outputting the amounts stored in the first and second storage sections.
